(19) United States
(12) Patent Application Publication
(10) Pub. No.: US 2024/0417659 A1
(43) Pub. Date: Dec. 19, 2024

(54) METHOD FOR PREPARING AN EXTRACT OF HERB(S) AND/OR SPICE(S) FROM A VINEGAR SALT

(71) Applicant: GALACTIC S.A., Escanaffles (BE)

(72) Inventors: Julien MORLOT, Escanaffles (BE); Philippe COSZACH, Escanaffles (BE); Jonathan WILLOCQ, Escanaffles (BE)

(21) Appl. No.: 18/702,689

(22) PCT Filed: Nov. 9, 2022
(86) PCT No.: PCT/EP2022/081356

§ 371 Date: Apr. 18, 2024

(30) Foreign Application Priority Data
Nov. 12, 2021 (BE) 2021/5877

(51) Int. Cl. C12J 1/08; A23L 27/10

(52) U.S. Cl. CPC C12J 1/08; A23L 27/11

(57) ABSTRACT

A method for preparing an extract of herb(s) and/or spice(s) is obtained by infusion from a vinegar salt or from a slightly reacidified vinegar salt, used as extraction solvent. Additionally, the method described for preparing an extract of herb(s) and/or spice(s) concerns the obtaining of a concentrated extract of herb(s) and/or spice(s) having an increased flavor content while limiting loss of vinegar when preparing the same.

### FIELD

The present disclosure relates to a novel method for preparing an extract of herb(s) and/or spice(s).

In particular, the extract of herb(s) and/or spice(s) obtained with the method of the present disclosure is prepared via infusion starting from a neutralized vinegar (buffered vinegar), in other words from a potentially reacidified vinegar salt used as extraction solvent.

In addition, the novel method for preparing the extract of herb(s) and/or spice(s) relates to obtaining of a concentrated flavor extract in liquid or solid form having an increased content of flavor(s), while limiting loss of vinegar when preparing the extract.

The present disclosure also relates to a method allowing easy varying of the content of flavor(s) in the extract of spice(s) using the vinegar salt as extraction solvent.

In the meat and bakery food sectors, buffered vinegars and the preparation methods thereof are known, starting from a vinegar in acid form.

It is also well known that the production mode of these buffered vinegars, prepared from a vinegar in acid form, allows classification as vinegar, thereby contributing toward “clean label (ling)” certification that is highly sought after by consumers.

However, it is also well known that these vinegars, in acid form, sometimes encounter relatively strong restrictions for application thereof and hence marketing restrictions impacted by taste or aroma that is too pronounced. The excessive volatility of vinegars in acid form notoriously impacts the appeal of foods in which they are incorporated.

To attenuate this drawback, it has already been proposed, with varying degrees of success, to mix these vinegars in acid form with flavored extracts. However, these extracts require labelling that imparts much less appeal to the product due to loss of “clean label (ling)” certification.

### BACKGROUND

In the prior art, methods are well known for preparing such vinegars in acid form whereby, from dried aromatic organic matter, complex solvent-based methods are used to extract and isolate aromatic molecules in the form of concentrated extracts. Included among the latter are: basil, thyme, laurel, clove, marjoram . . .

These extracts are then mixed with the vinegar in acid form, at varying doses, to attenuate the odor and/or pungent taste derived in particular from the acetic acid contained in the vinegar.

However, this preparation mode which allows producing of extracts of herb(s) and/or spice(s) solutions, not only requires certification procedure, but also leads to obtaining dilute vinegar solutions and as a result it is necessary to incorporate more vinegar to obtain efficacy, which only aggravates the issue of pungent taste.

It is known that the concentration of aqueous vinegar solutions is made complex by low separation factor between acetic acid and water. Fractional distillation columns comprising numerous stages having high reflux rates during operation are therefore required. Here again, high operating costs are to be expected and major energy expenditure unless recourse is made to fractional distillation with mechanical vapor compression. On this account, it is azeotropic distillation that has come to be used in practice.

Another option is to use the separation technique via membrane pervaporation, but this technique is also costly, linked to the fact that the membranes themselves can have very short lifetimes.

There is therefore a need for a simplified method to prepare a concentrated extract of spice(s) while reducing loss of vinegar when preparing this extract.

### SUMMARY

It is an aim of the present disclosure to provide a novel simplified method for producing an extract of herb(s) and/or spice(s) in liquid or solid form, using a vinegar salt as extraction solvent.

Another aim of the method of the present disclosure is to start from a vinegar salt that has been slightly reacidified, without however losing the properties and advantages of the novel method.

Another aim of the present disclosure is to develop this method which allows a drastic reduction in loss of vinegar during its preparation.

A further aim of the present disclosure is to provide a method which affords control over the content of flavor(s) in the extract of herb(s) and/or spice(s) obtained.

A still further aim of the present disclosure is to produce an extract of herb(s) and/or spice(s) which maintains food attraction without having to modify the composition thereof.

A yet further aim of the present disclosure is to produce an extract of herb(s) and/or spice(s) for which “clean label (ling)” certification can be obtained.

Applicant has now found that it is possible to prepare an extract of herb(s) and/or spice(s) meeting the aforementioned objectives, via infusion of a vinegar salt with a method comprising the following steps:
a. Providing a vinegar in acid form and neutralizing with a neutralizing agent selected from the group consisting of hydroxides, carbonates or bicarbonates of alkali metals, preferably of sodium or of potassium;
b. Concentrating the vinegar salt obtained;
c. Optionally, slightly reacidifying the vinegar salt obtained at step (b) with a vinegar in acid form, up to a pH of between 5 and 7;
d. Infusing the concentrated vinegar salt of step (b) or (c) with one or more fresh or dry or dehydrated herb(s) and/or spice(s), for a period of a few minutes to 22 hours and at a temperature of between 5° C. and the evaporation temperature of the vinegar used;
e. Filtering the infusate obtained at step (d);
f. Recovering the resulting liquid extract of herb(s) and/or spice(s).

Another embodiment of the present disclosure is a method comprising the following steps:
a. Providing a vinegar in acid form and neutralizing with a neutralizing agent selected from the group consisting of hydroxides, carbonates or bicarbonates of alkali metals, preferably of sodium or of potassium;
b. Concentrating the vinegar salt obtained;
c. Infusing the concentrated vinegar salt with one or more fresh or dry or dehydrated herb(s) and/or spice(s), for a period of a few minutes to 22 hours, at a temperature of between 5° C. and the evaporation temperature of the vinegar used;
d. Filtering the infusate obtained at step (c);
e. Spray drying the extract of herb(s) and/or spice(s) obtained at step (d);
f. Recovering the resulting solid extract of herb(s) and/or spice(s).

In the prior art, the starting point of the method is an alcohol vinegar. This alcohol vinegar is infused with dry aromatic material to extract therefrom the required aromas. This method leads to the aforementioned unpleasantness.

Applicant has surprisingly found that in a first preferred embodiment of the method of the present disclosure, starting from a vinegar neutralized with a neutralizing agent selected from the group consisting of hydroxides, carbonates or bicarbonates of alkali metals, preferably of sodium or of potassium, and preferably a vinegar neutralized with KOH, i.e. starting from a vinegar salt, better extraction of flavors is obtained.

In a second preferred embodiment of the method of the present disclosure, after the vinegar salt is obtained, it is concentrated by between 30% and 70%, preferably between 40% et 60%, and more preferably by about 50% before proceeding with the infusion operation.

In a third preferred embodiment of the method of the present disclosure, the vinegar obtained, after obtaining a vinegar salt according to any of the two modes mentioned above, can also be slightly reacidified by adding an amount of another vinegar in acid form.

The amount of this other vinegar is comprised between 1% and 25%, preferably between 2% and 20%, and more preferably between 5% and 15% by weight of vinegar salt. The amount of this other vinegar is selected to obtain a pH of between 5 and 7, without departing from the advantages of the method of the present disclosure.

In these three preferred embodiments of the method of the present disclosure, Applicant has surprisingly found that the loss of vinegar and of flavor is strongly reduced.

When the second and third preferred embodiments of the present disclosure are used, the concentration operation being performed on the salt and before infusion, Applicant has surprisingly found that, as in the first preferred embodiment, the loss of vinegar, but also of flavor, is strongly reduced.

This was particularly observed when the vinegar salt was flavored with basil, but also when flavoring with thyme, laurel, clove, marjoram or other similar herbs or spices.

In another embodiment of the present disclosure, the extract of herb(s) and/or spice(s) obtained after infusion and filtering of the infusate, is spray-dried and recovered in a powder form.

There are several advantages in using an extract of herb(s) and/or spice(s) in solid rather than liquid form; in particular, it is known that concentrated aqueous solutions of vinegar salt are not stable in liquid form over and above a certain concentration (e.g. over and above 32% for sodium acetate) since they tend to crystallize. The use in liquid form also requires more equipment depending on envisaged applications (pump, flowmeter . . . ). Logistics are also facilitated since there is no transporting of water.

Applicant has also found that with the method of the present disclosure, depending on concentrations and/or contact time of the infusion step, it is easily possible to vary the intensity or the dispensed flavor or flavors.

### DETAILED DESCRIPTION

According to the method of the present disclosure, the starting vinegar to prepare the extract of herb(s) and/or spice(s) of the present disclosure is a concentrated vinegar salt obtained for example as described in particular in Belgian patent BE 1024624 which can be summarized as follows:

In the method of the present disclosure, the starting concentrated vinegar salt is obtained from a first vinegar in the form of an aqueous acetic acid solution containing from 10% to 30% by weight of acetic acid relative to the weight of vinegar. Thereafter, this vinegar is neutralized with a neutralizing agent preferably selected from the group consisting of hydroxides, carbonates or bicarbonates of alkali metals, preferably of sodium or of potassium. In the present disclosure, preference is given to the use of potassium hydroxide and sodium hydroxide.

Neutralization is conducted at ambient temperature to prevent evaporation of the acetic acid into the environment. For example, neutralization takes place according to one of the following equations:

Acetic acid+KOH→K acetate+H2O

Acetic acid+NaOH→Na acetate+H2O

In the present disclosure, to prevent a powerful reaction at the neutralization step, the neutralizing agent is added slowly.

On completion of the neutralization reaction, a large part of the amount of water is evaporated, whether derived from the reagents or formed during neutralization. Since potassium acetate or sodium acetate are not or are only scarcely volatile under the conditions of ambient pressure and temperature, solely the water is evaporated.

When 50% to 80% of water has been extracted (evaporated), the evaporation step is stopped and, if necessary, the acid content can be adjusted to obtain a concentrated vinegar salt having the desired properties for the remaining flavoring operations.

Applicant has found that by using this type of vinegar salt to perform extraction of the flavor(s), the extraction of aromatic molecules is facilitated while incurring practically no loss of vinegar or flavor(s).

Without departing from the scope of the present disclosure, the infusion time can evidently be varied to increase extraction of flavor or flavors, and can therefore produce an extract of herb(s) and/or spice(s) having a strong concentration of flavor(s) used as base to prepare vinegar solutions having a lower flavor concentration.

In the method of the present disclosure, this vinegar salt is infused with basil or another herb or spice selected from the group already described above. The infusion step lasts from a few minutes to several days, preferably from a few minutes to 24 hours, for example from one minute, from 2, 3, 4, 5, 10, 20, 30, 40, 50, 60 minutes to 2, 3, 4, 5, 6, 7, 8, 9, 10, 12, 14, 16, 18, 20, 22, 24, 30, 36 or 48 hours; this period can be increased by one or even several days without, however, contributing any added value to the infusion operation.

The infusion step is conducted at a temperature comprised between 5° C. and the evaporation temperature of the vinegar used, preferably between 5° C., 6° C., 7° C., 8° C., 9° C., 10° C., 12° C., 14° C., 16° C., 18° C., 20° C., 22° C., 24° C., 26° C. and 30° C., 35° C., 40° C., 45° C. and 50° C., and more preferably at ambient temperature.

Applicant has found that by conducting the infusion step following this method, the extraction yield is higher than with usual methods.

The method of the present disclosure can therefore be carried out by indifferently varying the contact time with the vinegar salt and the concentration of the herb or spice (in fresh, dry, or dehydrated form) according to the desired intensity of taste or aroma. The concentration of herb or spice can vary as a function of the form thereof (fresh, dry, dehydrated) and is between 0.05% and 25% by weight of the vinegar salt solution, more preferably between 0.075% and 15% by weight of the vinegar salt solution, and further preferably between 0.1% and 10% by weight of the vinegar salt solution.

The Applicant has also surprisingly found that by varying the infusion parameters, the method of the present disclosure allows either simple neutralization of the odor of vinegar by the aroma of the herb(s) and/or spice(s), or whole replacement thereof advantageously by an aroma of herb(s) of which the intensity can be varied.

The herbs or spices able to be used in the present disclosure are selected from the group comprising, preferably consisting of basil, thyme, laurel, clove, marjoram, or other similar herbs or spices. In the present disclosure, the herb(s) and/or spice(s) can be used alone or in mixtures.

The herbs or spices are generally available in fresh form, dry form, or dehydrated form. The infusion method of the present disclosure can be performed starting with the three forms.

After the infusion step of the vinegar salt, the extract of herb(s) and/or spice(s) obtained is recovered. The extract of herb(s) and/or spice(s) can then be filtered using any technique known to the skilled person, if this proves to be necessary. The aim of the separation step, and optionally filtering step, is to separate the herb or herbs from the flavored solution.

In another embodiment of the present disclosure, the extract of herb(s) and/or spice(s) obtained after this infusion and separation step is spray-dried under operating conditions known to skilled persons, and is recovered in solid form.

The method of the present disclosure is also described with the examples below given by way of illustration, but without limiting the scope thereof.

### EXAMPLE 1

Several extracts of herb(s) were prepared by infusing 4 base vinegars of which two conformed to the method of the present disclosure. These base vinegars are designated by the letters (A), (B), (C) and (D) and are defined as being:
a raw vinegar, designated (A), in acid form and having 18% concentration;
vinegar (A) neutralized with KOH, i.e. a vinegar salt designated (B);
the vinegar salt (B), concentrated and slightly reacidified following the procedure described in patent BE 1024624, designated (C).
vinegar (A) neutralized with NaOH, i.e. a vinegar salt concentrated and slightly reacidified following the procedure described in patent BE 1024624, designated (D).

The herbs used for conducting these tests were fresh basil and fresh thyme used under set conditions: 5 weight % of herb (by weight of the vinegar solution), 16 hours infusion under orbital shaking at ambient temperature, followed by filtration before visual and organoleptic evaluation by a panel.

A total of 12 samples were generated as given in Table 1 below.

The principle of organoleptic evaluation was to submit the samples to be tested to several trained panel members. Each panel member was requested to associate the sample with the dominant organoleptic property determined according to his or her own evaluation. Standard samples were provided as reference. These tests were blind tests i.e. the samples were not named, within a fully neutral environment without any parasitic odors.

The results are expressed as a mean of the different panel member scores for each sample, and give the chief aroma noted and the color number measured on the Gardner scale.

Color was measured and expressed on the Gardner scale. This scale applies to transparent liquids to measure coloring in shades of yellow/orange/brown; the maximum number is Gardner 18.

TABLE 1

| | | Dominant | |
|---|---|---|---|
| | | organoleptic | Gardner |
| Liquid raw material | Herb | property | color |
| Vinegar (A) | — | Vinegar+++ | 0.2 |
| Vinegar salt (neutralized with | — | Vinegar+ | 0.3 |
| KOH) (B) | | | |
| Vinegar salt, concentrated and | — | Vinegar++ | 0.7 |
| acidified (C) | | | |
| Vinegar salt (neutralized with | — | Vinegar++ | 0.6 |
| NaOH), concentrated and | | | |
| acidified(D) | | | |
| Vinegar (A) | Fresh basil | Basil+ | 0.9 |
| Vinegar salt (neutralized with | Fresh basil | Basil+++ | 2.4 |
| KOH) (B) | | | |
| Vinegar salt, concentrated and | Fresh basil | Basil++ | 2.2 |
| acidified (C) | | | |
| Vinegar salt (neutralized with | Fresh basil | Basil++ | 2.3 |
| NaOH), concentrated and | | | |
| acidified (D) | | | |
| Vinegar (A) | Fresh | Thyme+ | 0.8 |
| | thyme | | |
| Vinegar salt (neutralized with | Fresh | Thyme+++ | 2.2 |
| KOH) (B) | thyme | | |
| Vinegar salt, concentrated and | Fresh | Thyme++ | 2.0 |
| acidified (C) | thyme | | |
| Vinegar salt (neutralized with | Fresh | Thyme++ | 2.2 |
| NaOH), concentrated and | thyme | | |
| acidified(D) | | | |

The results of these tests clearly show differences between vinegar (A) and the tested vinegar salts (B), (C) and (D).

The vinegar samples of type (A) (raw in acidified form) infused with fresh basil, and vinegar (raw in acidified form) infused with thyme, exhibit visual and organoleptic properties close to those of raw non-infused vinegar (pungent effect and little aroma).

On the contrary, the tests conducted with samples prepared starting with vinegar salt of type (B), (C) or (D) (whether neutralized with KOH or NaOH, whether or not concentrated and reacidified) and infused, unexpectedly exhibit much more pronounced coloring and an organoleptic profile typical of the corresponding infused herb; this is valid irrespective of the herb used.

The fact that infusion is more efficient for the vinegar salts of type (B), (C) or (D), of which (C) and (D) are concentrated and reacidified, is of particular interest since the risk of loss of acetic acid (related to the volatility thereof) and loss of flavors derived from infusion are advantageously considered negligible (no concentration required after infusion).

### EXAMPLE 2

Vinegar (A) and the vinegar salt (C) in Example 1 were selected from which 2 samples were prepared at an equivalent concentration of total acetic acid and under the same infusion conditions as in Example 1.

Vinegar (A) was infused with 5 weight % (by weight of the vinegar solution) of fresh basil for 16 hours at ambient temperature under orbital shaking, then concentrated to reach a total acetic acid content equivalent to that of vinegar (C).

Vinegar salt (C) was simply infused under strictly identical conditions.

Both samples were compared from the aspects of yield (i.e. ratio between the amount of total acetic acid before and after concentration) and organoleptic property.

Table 2 gives the conditions and results of the test:

TABLE 2

| | Dominant | |
|---|---|---|
| | organoleptic | |
| Sample | property | Yield |
| Vinegar (A) infused and concentrated | Vinegar++ | 66% |
| Infused vinegar salt (C) | Basil++ | 97% |

The test results show that it is preferable:
to evaporate water on a vinegar salt, to prevent poor yield;
to infuse after the concentration step, to maintain the aromatic molecules (and hence the organoleptic properties of the added herb) within the sample.

### EXAMPLE 3

The vinegar salt (C) in Example 1 was again used to prepare 16 samples for which the following parameters of the method were subjected to variations: the weight concentration of herb(s), infusion period, form in which the herb was used either fresh, dry or dehydrated. This allowed comparison of the results obtained.

In this example, only basil was used as the herb, but similar results were obtained with thyme and with other herbs.

A comparative test for taste and aroma on the infused and filtered solutions was conducted. An organoleptic panel was set up to identify the dominant organoleptic characteristic (same protocol as in Example 1).

All the parameters and test results are given in Table 3 below:

TABLE 3

| | | | | Dominant | |
|---|---|---|---|---|---|
| | Herb weight | Infusion | | organoleptic | Gardner |
| Herb form | concentration | period | | property | color |
| Fresh | 3.0% | 10 | minutes | Vinegar+ | 0.9 |
| Fresh | 0.1% | 1 | h | Vinegar++ | 0.7 |
| Fresh | 0.5% | 1 | h | Vinegar+ | 0.9 |
| Fresh | 1.0% | 1 | h | Vinegar+ | 1.0 |
| Fresh | 3.0% | 1 | h | Neutral | 1.2 |
| Fresh | 0.1% | 4 | h | Neutral | 0.9 |
| Fresh | 0.5% | 4 | h | Neutral | 1.1 |
| Fresh | 1.0% | 4 | h | Basil+ | 1.6 |
| Fresh | 3.0% | 4 | h | Basil++ | 2.1 |
| Dehydrated | 0.1% | 4 | h | Vinegar++ | 0.9 |
| Dehydrated | 0.5% | 4 | h | Vinegar+ | 1.3 |
| Dehydrated | 1.0% | 4 | h | Neutral | 1.9 |
| Dehydrated | 3.0% | 4 | h | Basil+ | 2.5 |
| Dehydrated | 0.1% | 24 | h | Vinegar+ | 1.0 |
| Dehydrated | 0.5% | 24 | h | Neutral | 1.6 |
| Dehydrated | 1.0% | 24 | h | Basil+ | 2.2 |
| Dehydrated | 3.0% | 24 | h | Basil++ | 2.9 |
| Dehydrated | 3.0% | 48 | h | Basil++ | 3.0 |

Table 3 above shows that by varying the weight of the infusion parameters, it is possible either simply to neutralize the vinegar odor by the aroma of basil, or altogether to replace this odor by the aroma of basil of which the intensity can be adapted and modified.

It is also of interest to note that, all other parameters being equal, a larger quantity of dry or dehydrated basil is needed to obtain an equivalent organoleptic effect.

Monitoring of the color of these same samples corroborates the observations and conclusions obtained from the organoleptic data.

### EXAMPLE 4

A herb extract was prepared by infusion in a vinegar neutralized with NaOH, i.e. a vinegar salt, up to a pH of 7.5, concentrated in a double-effect evaporator to 34% and then reduced to 32%.

Basil was directly added in a proportion of 1% for 6 hours at ambient temperature and under agitation.

The solution obtained was filtered a first time on a 50 μm bag filter, then a second time on a 1 μm bag filter.

The herb extract obtained was spray dried in a multiple-effect drying tower having an evaporation capacity of 10 to 15 Kg/h, under the conditions given in Table 4.

TABLE 4

| | | Spray | | |
|---|---|---|---|---|
| | | nozzle | | Temperature |
| Liquid flow | Type of | pressure | Temperature | AIR OUT |
| rate(kg/h) | injection | (bar) | AIR IN (° C.) | (° C.) |
| 18 | Bi-fluid | 4 | 161 | 84 |
| | nozzle | | | |

The characteristics of the solid herb extract obtained are given in Table 5.

TABLE 5

| | Water concentration | Sodium acetate |
|---|---|---|
| Sample | (ppm) | concentration (%) |
| Herb extract after | 4099 | 98.54 |
| drying | | |

A test on taste and aroma was conducted on the solid herb extract, the results are similar to those obtained in Table 2.

### EXAMPLE 5

Vinegar (A) in Example 1 and the solid herb extract of Example 4 were used in a «steak burger» matrix to determine the dominant aromatic note.

Table 6 gives the compositions of the two matrices:

TABLE 6

| Composition of burgers | Sample 1 (%) | Sample 2 (%) |
|---|---|---|
| Beef meat | 98 | 98 |
| Salt | 1 | 1 |
| Vinegar (A) | 1 | — |
| Solid herb extract | — | 1 |

The products were placed on a baking tray covered with baking sheet, placed in a preheated oven at 210° C. for 5 minutes, turned over and again baked for 5 minutes before being submitted for tasting to a panel composed of 10 persons trained in sensorial analysis techniques.

The results are expressed as a mean of the scores of the different panel members for each sample, and are given in Table 7.

TABLE 7

| | Dominant organoleptic |
|---|---|
| Sample | property(ies) |
| Sample 1 | Pungent, vinegar |
| Sample 2 | Meaty, salted, spicy |

The results of these tests clearly show differences between the sample prepared with vinegar (A) and the sample prepared with the solid herb extract of Example 4.

1. A method for preparing an extract of herb(s) and/or spice(s) by infusing a vinegar salt, the method comprising:
a. Providing a vinegar in acid form using a neutralizing agent selected from the group consisting of hydroxides, carbonates or bicarbonates of alkali metals;
b. Concentrating the vinegar salt obtained;
c. Infusing the concentrated vinegar salt of step (b) with one or more fresh, dried, or dehydrated herbs and/or spices, for a period of a few minutes up to 22 hours at a temperature of between 5° C. and the evaporation temperature of the vinegar used;
d. Filtering the infusate obtained at step (c);
e. Recovering the resulting liquid extract of herb(s) and/or spice(s).

2. A method for preparing an extract of herb(s) and/or spice(s) by infusing a vinegar salt, the method comprising:
a. Providing a vinegar in acid form and neutralizing with a neutralizing agent selected from the group consisting of hydroxides, carbonates or bicarbonates of alkali metals;
b. Concentrating the vinegar salt obtained;
c. Infusing the concentrated vinegar salt with one or more fresh, dried, or dehydrated herbs and/or spices for a period of a few minutes up to 22 hours at a temperature of between 5° C. and the evaporation temperature of the vinegar used;
d. Filtering the infusate obtained at step (c);
e. Drying the extract of herb(s) and/or spice(s) obtained at step (d)
f. Recovering the resulting solid extract of herb(s) and/or spice(s).

3. The method according to claim 1, wherein the vinegar salt is concentrated to a value comprised between 30% and 70%.

4. The method according to claim 3, wherein the vinegar salt is concentrated to a value comprised between 40% and 60%.

5. The method according to claim 1, further comprising reacidifying the vinegar salt obtained at step (b) with a vinegar in acid form, up to a pH of between 5 and 7; wherein the quantity of vinegar in acid form added for reacidification is comprised between 5% and 15% by weight of the vinegar solution.

6. The method according to claim 1, wherein the infusion step is conducted for a period of 5 minutes to 22 hours and at a temperature comprised between 5 and 50° C.

7. The method according to claim 6, wherein the infusion step is conducted for a period longer than 1 hour.

8. The method according to claim 1, wherein the herb or spice is selected from the group consisting of basil, thyme, laurel, clove, and marjoram.

9. The method according to claim 2, wherein the drying step is performed by spray drying.

10. A method for varying the flavor content of an extract of herb(s) and/or spice(s) obtained with the method according to claim 1, wherein the infusion step of the method of claim 1 is performed with a herb concentration comprised between 0.05% by weight and 25% by weight of the vinegar solution for a period of 5 minutes to 22 hours and at a temperature comprised between 5° C. and a temperature lower than the evaporation temperature of the vinegar used.

11. The method according to claim 10, wherein the herb concentration is higher than 0.1%.

12. The method according to claim 10, wherein the infusion step is conducted at a temperature comprised between 5° C. and 50° C.

13. The method according to claim 10, wherein the infusion step is conducted at ambient temperature.

14. An extract of herb(s) and/or spice(s) obtained with the method according to claim 1.

15. The method according to claim 1, further comprising reacidifying the vinegar salt obtained at step (b) with a vinegar in acid form, up to a pH of between 5 and 7.
